(19) United States
(12) Patent Application Publication
(10) Pub. No.: US 2013/0190428 A1
(43) Pub. Date: Jul. 25, 2013

(54) Wood Composite Process Enhancement

(71) Applicant: Hercules Incorporated, Wilmington, DE (US)

(72) Inventor: Daniel Varnell, Wilmington, DE (US)

(73) Assignee: HERCULES INCORPORATED, Wilmington, DE (US)

(21) Appl. No.: 13/746,610

(22) Filed: Jan. 22, 2013

Related U.S. Application Data
(60) Provisional application No. 61/589,580, filed on Jan. 23, 2012.

(51) Int. Cl. C08L 1/02

(52) U.S. Cl. CPC C08L 1/02
USPC 524/18

(57) ABSTRACT

Disclosed is a method of preparing a lignocellulosic composite; the method comprising the steps of combining one or more dry protein sources as powders and one or more lignocellulosic materials; subsequently combining with the protein and lignocellulosic combination, a liquid mixture comprising a curative for the protein source, forming the resulting mixture into a composite structure and then curing the composite structure.

This application claims the benefit of U.S. provisional application No. 61/589,580, filed 23 Jan. 2012, the entire contents of which are hereby incorporated by reference.

### FIELD OF THE INVENTION

The current invention is directed to the processes of preparing lignocellulosic based composites, which are bonded with an adhesive comprised of a protein source, wherein the protein source is added as a powder to the lignocellulosic component prior to or at the same time as a liquid curative is applied.

### BACKGROUND OF THE INVENTION

In most composite manufacturing processes that utilize an adhesive, the adhesive portion sets up. That is the adhesive portion goes from being a liquid to a solid. The adhesive may set up by loss of water into the air or into another portion of the composite, or by a phase change, or by some chemical or physio-chemical change of the adhesive.

Many adhesives in the composite industry, especially where biomaterials are used, are water-borne. That is water serves as a primary component either to dissolve or disperse the adhesive components. For example urea-formaldehyde (UF) adhesives are often provided in the form of a dispersion in water. Most latex adhesives are emulsions or dispersions based on water. Historical and more recent protein based adhesives are water based. Various water based adhesives are described in numerous books, articles, and patents. See, for example, patents describing soy flour based adhesives (such as U.S. Pat. Nos. 7,060,798 and 7,252,735). Similar work exists for urea formaldehyde (UF) based adhesives, melamine urea formaldehyde (MUF) adhesives, melamine formaldehyde (MF) adhesives, phenol formaldehyde (PF) adhesives, and poly(vinyl acetate) and poly(ethylene vinyl acetate) adhesives.

Many formaldehyde based resins, such as urea formaldehyde resins are very strong, fast curing, and reasonably easy to use. However, such resins lack hydrolytic stability along the polymer backbone. There can be significant amounts of free formaldehyde released from the finished products (and ultimately can be inhaled by the occupants within a home). There have been several legislative actions to push for the removal of these resins from interior home applications (Health and Safety Code Title 17 California Code of Regulations Sec. 93120-93120.12). The protein based adhesives of the current invention do not require formaldehyde.

In one particular class of adhesives, protein sources, such as soy protein isolate or soy flour, are used in combination with a curative. The curative may also be called a crosslinking agent or even called a catalyst. The curative reacts with or it reacts in the presence of the protein source to achieve superior properties of the composites, such as improved bending strength or water resistance versus use of the protein alone. Soy protein based adhesives are described in numerous patents including recent ones such as U.S. Pat. Nos. 7,736,559; 7,345,136; 7,393,930; 7,252,735; 7,060,798; 6,497,760; 6,306,997 and older ones such as U.S. Pat. Nos. 1,994,050; 1,813,387; and 1,724,695 and in articles such as Yang et al. Comparison of protein-based adhesive resins for wood composites, J Wood Sci. (2006) 52: 503-508 and Kumar et al. Adhesives and plastics based on soy protein products, Industrial Crops and Products 16 (2002) 155-172.

The above historical references describe how a protein source is dispersed in water and then mixed with a curative, and possibly other additives, to yield adhesives that can be rolled, sprayed, or otherwise applied to the lignocellulosic components to form a composite. For example, in preparation of particleboard, or medium density fiber (MDF) board the adhesive is sprayed onto and mixed with the lignocellulosic component, which is most commonly wood.

One key aspect of the present invention is the addition of the protein source as a powder, not mixed with a curative, to the lignocellulosic prior to application or at the same time as application of the curative.

U.S. Pat. No. 6,306,997 by Kuo describes soy-bean based adhesive formulations of neutral pH. The process described begins with making an aqueous solution of soybean flour.

U.S. Pat. No. 7,060,798 by Li uses soy flour and starts with the preparation of an aqueous adhesive composition which once made is applied to the lignocellulosic materials.

U.S. Pat. Nos. 7,722,712 and 8,268,102 relate to adhesive compositions containing at least one boron compound and are solely aqueous based.

U.S. Pat. No. 7,803,855 by Kinzley et al. relates to wood composite adhesive compositions that combine phenol-formaldehyde, polyvinyl ester, and protein based materials.

U.S. Pat. No. 6,790,271 describes the composition of an adhesive based on soy protein, plasticizer, and a vegetable oil derivative. The patent includes application of powder materials to the lignocellulosic. However, the patent teaches that the materials, including the curative, must be premixed to produce a homogeneous powder where the particles easily separate. This blend is then applied to wood in the preparation of particleboard. It is not taught or recognized that the soy protein portion could be added separately to the wood. In fact, great detail is used to describe how the protein and the other liquid components are mixed. Methods are described for premixing the components, such as ball mill mixing.

U.S. Pat. No. 7,855,440 relates to an adhesive composition resulting from the reaction product of soy flour and a resin from an adduct of epichlorohydrin with a PAA resin.

When an adhesive is to be sprayed onto the lignocellulosic of a composite there will be certain viscosity restrictions dictated by the spraying process. For example in the manufacturing of particleboard the adhesive is sprayed onto the lignocellulosic (typically wood) and then the mixture is further blended. The adhesive formulation must be in a sprayable form. A sprayable form means that the viscosity must be below a certain threshold. With some water and protein based adhesives, including the use of soy flour, as part of a liquid solution or dispersion, the viscosity can increase rapidly with the protein concentration. Therefore, the concentration must be kept low.

At the same time adhesives for water-based composites also have limitations on the solids that can be used. Too much water added to the composite by the adhesive can prevent the successful manufacturing of the composite. There could be too much shrinkage, or if curing by hot-pressing, too much steam pressure may build inside the formed structure. The pressure can lead to delaminating of the structure or blowing apart of the structure when pressure is released. Both are common problems in the manufacturing of particleboard.

U.S. Pat. No. 7,736,559 describes compositions of adhesives based on soy flour and a polyamidoamine/epichlorohydrin curative. Moisture limits, well known to the industry for the manufacturing of composites, are stated as being a limitation in the manufacturing of wood composites. Included are the typical wood moisture, solids contents of a curative, and typical adhesive addition levels. The patent attempts to distinguish the invention by looking at the specific mixture of just the wood, amine curative, and protein source and stating that it must have a total moisture input, defined by a particular equation, of between 8 and 12% of the wood component. The equation is limited to the wood, amine curative, and protein source. The patent further notes that to obtain this level of moisture it can be beneficial to add the protein source, such as soy flour, as a dry powder to the curative portion. The patent describes the addition process as the protein “blended or mixed into an aqueous suspension of solution of the . . . amine.” The soy flour is not premixed with the wood. In an example this addition is done by sprinkling the soy powder into the blender containing the wood and adhesive. The sole purpose given for the use of a powder protein component is reduction of moisture level to meet the moisture input equation.

The use of diluents or plasticizers with proteins, especially soy protein, is mentioned in many patents and articles. The high viscosity of protein materials and the need to limit water has been addressed by the addition of diluents, as described in US Patent publication 2009/0098387 A1. Water is replaced by diluents in a solution or dispersion of protein thus keeping both the protein level and the water level low. A combination of a certain level of diluents and a limit to the soy flour level are needed to keep the viscosity low and the moisture level low.

The addition of urea as an additive is known. U.S. Patent publication 2010/0069534 A1, by Wescott, describes the advantages of adding urea to a soy flour based composite adhesive. The urea is added to a wet composition of soy flour. It can be a diluent, but it may be more accurately described as an aid to denature the soy protein and thus enhance properties. However, soy flour can contain the enzyme urease which would break down the urea into ammonia and carbon dioxide. Urease may be eliminated with heat treatment. U.S. Patent Publication 2011/0048280 utilizes an acidification to eliminate urease enzyme. The processes needed to kill or inhibit the urease add complexity and cost to the process of using soy flour or other protein sources that contain urease.

U.S. Pat. No. 5,582,682 covers the process of making cellulosic composites with a thermoset adhesive that utilizes the Maillard reaction where both the carbohydrate for the Maillard reaction and a solids-residue are derived from the same particulated cellulosic feedstock. In the process the cellulosic feedstock and a protein containing material are mixed and treated with ammonia to obtain the composite forming mixture. The ammonia must be present in high enough concentration to increase the pH to alkaline and start the Maillard reaction which is seen to occur by a deep darkening of the materials. The process is considered dry because there is no free liquid. The “no liquid” adhesive of the patent is premade and then applied to the solids residue. With the current invention the cellulosic and the protein source are not from the same feed stock and the total adhesive is not premade.

Most composites are shaped prior to the setting up of the adhesive. In operations, such as the manufacturing of particleboard, layers of treated biomaterial, such as wood particles or chips, are formed, then cold pressed to form an uncured mat, and then hot-pressed to set-up the adhesive. For such cases the molded form is a large planer sheet. For other applications the shape might be more complex, such as that of a flower pot or door molding.

In some processes, the shaped part must have some integrity even before the adhesive has set-up. This structural integrity may be referred to as green strength or cohesive strength or tack. Tack is the term typically used at a particleboard manufacturing site. Tack can also refer to the impartation of such cohesive strength by the adhesive portion of the composite. In the formation of something like a composite structure in the shape of a bowl the need for tack would be required if the bowl were free standing during the process when the adhesive has yet to set. Tack is also required even of materials formed into sheets. For example, on some particleboard manufacturing lines the formed mat is divided into sheets of the size of a final board product in the planer directions and then the sheets travel to a heated press. As the boards travel to the press they may span a gap and be unsupported for a time (a line without a caul). In this and other operations the uncured shaped composite structure requires some cohesive strength for the shape of the uncured composite to be maintained and to be void of cracks or fissures or other defects that might occur because of a lack of tack. Often an adhesive, for the composites, is said to have bad or good tack properties. For many applications the lignocellulosic provides no tack and does not retain a structure as an uncured material in the absence of an adhesive.

It is recognized in the composite industry that some adhesives provide good tack and others do not. The effect of the composition of UF (urea formaldehyde) adhesives on tack is discussed in an article by Leichti, Hse, and Tang, “J. Adh, 1988, pp 31-44. UF resins are generally considered to have good tack. MDI based adhesives are generally considered to have very poor tack. Some environmentally friendly adhesives can have good tack and tack often depends on the protein level. However, if the protein is first dissolved or dispersed in water, the level at which the protein source is added to the adhesive is very limited before viscosity becomes unmanageable, especially for adhesives that are sprayed on the lignocellulosic.

### BRIEF SUMMARY OF THE INVENTION

The process of the present invention provides a means in the manufacturing of lignocellulosic composites for reducing or eliminating issues with the dispersing of a protein source in water and the limitations of solids content of a protein and curative dispersion. The present invention also reduces or eliminates problems with trying to spray a high viscosity solution or dispersion of a protein source. The invention also reduces or eliminates the need to neutralize urease in the protein source before it is used as an adhesive when urea is part of the adhesive formulation or part of the composite. In some embodiments the process of the current invention may lead to better tack during forming of the composites and enhanced strengths of the final composites.

The current invention provides a process of preparing lignocellulosic based composites, which are bonded with an adhesive comprised of a protein source, wherein the protein source is added as a powder to a dry lignocellulosic component prior to or at the same time as a liquid curative is applied. In general the lignocellulosic composition comprises the lignocellulosic material (furnish) and the components that make up the adhesive, such as the protein and the curative. The lignocellulosic composition may also include other additives such as urea or diluent. The invention also provides for the same process wherein the pH of the treated lignocellulosic composition for preparing the board increases from the time the dry lignocellulosic material is combined with the protein source and other additives to the time the lignocellulosic composition is pressed into the final composite structure or before it is cured. The invention further provides for improvements derived from the process which provide better tack of the composite structure before curing and improved strength of the final composite.

Lignocellulosic-based composites, such as particleboard, are prepared from combinations of lignocellulosic materials such as wood, and a binder, also known as a resin and/or adhesive. Therefore, a lignocellulosic composition comprises a lignocellulosic material held together by an adhesive.

One aspect of the present process is to mix a powder of a protein source with the dry lignocellulosic material prior to application of any other component of the adhesive, for example, a curative. The protein and curative are never premixed. Another aspect is to obtain a more uniform distribution of the powder protein source and thus the adhesive on the lignocellulosic component by mixing a powder protein source and the lignocellulosic component as dry materials (dry materials meaning the solids are movable as particles or pieces and there is no visible water) as compared to spraying the entire adhesive, as a liquid, onto the lignocellulosic. Another aspect of the process is to use a protein source that contains urease and to include urea as a component of the final composite. Another aspect is to obtain a low moisture content for the entire composite structure prior to pressing or curing. For example a combination of addition of a protein based adhesive of 50% solids at 7 parts dry weight basis of the wood with 93 parts wood, dry basis, having 5% moisture content, would lead to a total moisture content of 8.15% of the dry materials. If instead 4 parts soy flour at 93% solids was added to the wood and separately 3 parts of a curative portion at 50% solids was added, then the final total moisture content is 6.43%. Another aspect of the invention is that a low solids curative may be used or a much high wood moisture level may be used in the preparing of the composite because of the low level of moisture added with the dry protein source. Another aspect is to obtain an increase of the pH of the treated composite furnish during the process of making the composite. Another aspect is to use a curative that performs better because of the increased pH with increased pH resulting from the combination of urea and urease.

### DETAILS OF THE INVENTION

### Composite Formulations

The current invention is directed to the processes of preparing lignocellulosic based composites, which are bonded with an adhesive comprised of a protein source, wherein the protein source is added as a powder to the lignocellulosic component prior to or at the same time as a liquid curative is applied. The invention is further directed to the same process wherein the pH of the composite's treated furnish for preparing the board increases from the time the lignocellulosic is treated to the time the furnish is pressed into the final composite. The invention is further directed to the improvements derived from the process which are better tack of the composite's treated furnish and improved strength of the final composite. The current invention provides a means for obtaining good tack using a protein based adhesive because it allows for addition of more protein. It also provides more tack at an equal protein level as compared to a method where the protein is added via an aqueous mixture.

The current invention addresses many of the needs left unmet by the prior technologies. Better strength performance, easier manufacturing, lower cost, and elimination of the need to neutralize urease when using urea are among the potential benefits. Also provided is a means for increasing pH for enhanced performance of some curatives.

Composites are composed of multiple materials, typically a primary material, such as wood or a type of fiber or type of filler that is held together by an adhesive. An adhesive used for composites may also be referred to as a binder or resin. The primary material comprises the major part of the composite in a range from about 40% to about 99% by volume, can be from about 55% to about 98% by volume, can be from about 70% to about 98% by volume and may be from about 80% to about 98%. The adhesive portion comprises from about 1% to 60% of the composite by volume, can be from about 2% to about 45% by volume, can be from about 2% to about 30% and may be from about 2% to about 20%.

For the current invention the composite primary material is a lignocellulosic. The lignocellulosic can be referred to as the Furnish. The most common lignocellulosic is wood. The lignocellulosic primary materials may come in various forms and shapes. Examples of lignocellulosics in fiber form include but are not limited to: wood fibers; plant fibers, such as derived from bamboo, soy bean plants, sugar cane; and cellulose fibers such as pulp as used in paper. Carbonized forms of these can be used. Some common lignocellulosics in the form of powders include, but are not limited to, soy bean hulls, nut shells, bamboo powder, and wood dust. Chips and flakes of lignocellulosic materials may also be used.

When the lignocellulosic component of the composite is wood it can be as wood fibers, dust, particles, chips, or flakes. Small particles of wood and sometimes wood dust are used in making particleboard and wood in the form of small fibers is used in making medium density fiber board (MDF). In one embodiment of this invention the composite structure is particleboard and in another embodiment it is MDF.

In the composites of the current invention the primary materials are held together or bonded together or glued together by an adhesive. For many lignocellulosic composites the most common adhesives are urea-formaldehyde resins and phenol formaldehyde resins. The current invention is applicable to adhesives that are based on a protein source mixed with a curing agent otherwise called a curative. The current invention is also applicable to complex composites where different composite compositions and/or structures are combined, for example a multilayer particleboard. The current invention may be applied to only one portion of the composition or structure. For example, the core of a particleboard may be made by a standard industrial process using a UF, MUF, isocyanate-based, or some other adhesive and the face can be prepared using the current process. In such cases the advantages of the current process may overcome deficiencies of the other portions of the composite. For example, when making particleboard, the excellent tack of the current process can overcome a core layer of the particleboard that has insufficient tack to be processed on all industrial lines or the low moisture content possible with the current process can compensate for a high moisture content in the core layer of an uncured particleboard.

Suitable protein sources or components on which the adhesive may be based include, but are not limited to, soy protein isolate, soy protein concentrate, soy flour, corn gluten meal, whey protein, wheat gluten, dried egg whites, gelatin, peanut flour, lupin flour, other high protein flours, feather meal, keratin, blood meal, collagen, gluten, casein, and spirulina. Various grades of these materials are included. For example soy flours come with a different protein dispersability indexes (PDI), for example 90 or 20. The PDI is a means of comparing the solubility of a protein in water, and is widely used in the soybean product industry. A sample of the soybeans is ground, mixed with a specific quantity of water, and then blended together at a specific rpm for a specific time. The protein content of the resulting mixture and original bean flour are then measured using a combustion test, and the PDI is calculated as the percentage of the protein in the mix divided by the percentage in the flour. For instance, a PDI of 100 indicates total dispersability. PDI is affected not only by the type of soybean used, but also by any manufacturing processes used on the soy. For instance, heat can lower the PDI of a soybean sample.

There can be certain advantages to using different PDI materials. The PDI of the protein source (as measured by the method used for soy flours) can be greater than 50 and may be greater than 70. A mixture of protein sources may be used and may provide advantages over the use of a single material. For the current invention it is necessary that the protein source be a powder which is capable of being dispersed onto or mixed well with the lignocellulosic component. The average particle size of the protein source as used as a powder can be below 200 microns, can be below 100 microns can be below 50 microns and may be below 25 microns. The protein sources may be pretreated or modified as long as they can be returned to a dry powder form prior to use. The protein source can be at least 50% soy flour.

The level of protein source needed in the process of the current invention depends on the percentage of protein in the source material. For example soy flour is typically about 50% protein by weight whereas a soy concentrate may contain 70% protein. For the current process the actual overall protein level added to the composite on a dry weight percent of the lignocellulosic component should be between 0.5 percent and 15 percent inclusive and can be between about 0.8 percent and 10 percent and may be between about 1 percent and 5 percent.

In the current invention, when soy flour is used as the protein source, the level can be greater than 2 parts per hundred parts of the lignocellulosic material on a dry weight basis, and may be at least 3 parts per hundred parts on a dry weight basis. The soy flour can be a high dispersability soy flour of PDI greater than 50.

Many materials may be used as curatives for proteins. The protein based adhesive of the present invention can also comprise a curative. The curative may also be known as or referred to as a cure additive, crosslinking agent or catalyst. The curative may provide additional or manipulate existing properties of a protein adhesive, such as water resistance, solubility, viscosity, shelf-life, elastomeric properties, biological resistance, strength, and the like. Kumar et al. describes many of the aspects of curing protein adhesives in an article Adhesives and plastics based on soy protein products, Industrial Crops and Products 16 (2002) 155-172. Curatives may be materials that react with some portion of the protein source, enhance the cure of the protein source, co-cure with the protein source, or cure separately but as a network with the protein source. Some examples of curatives include epoxies, isocyanates, sulfur compounds, aldehydes, anhydrides, silanes, azididines, and azetidinium compounds and compounds with all such functional groups. Possible formaldehyde-containing crosslinking agents include formaldehyde, phenol formaldehyde, urea formaldehyde, melamine urea formaldehyde, melamine formaldehyde, phenol resorcinol and any combinations of them.

The present invention is not limited to the above list and other curatives are known in the art. For example polyvinylacetate latexes and similar compounds can be used. For the current invention the curatives can be polyamidoamine-epichlorohydrin (PAE) type resins. They are a family of compounds well known in the paper industry for providing wet strength to paper. The role of a curative, regardless of type, is to set-up the adhesive. This is achieved with crosslinking agents that have several reactive sites per molecule. The type and amount of curative used in the present invention depends on what properties are desired. Additionally, the type and amount of curative used may depend on the characteristics of the protein source used in the adhesive.

Any curative known to the art may be used in the method of the present invention. For instance, the curative may or may not contain formaldehyde. The curative can be formaldehyde free and not manufactured using formaldehyde. Although formaldehyde-free curatives are highly desirable in many interior applications, formaldehyde-containing curatives are acceptable for some exterior applications. The current process can lead to a composite that emits less than 0.09 ppm formaldehyde and can emit below 0.05 ppm formaldehyde using the “large chamber” method described by the California Air Resource Board (CARB) and based on the test method ASTM E 1333-96(2002). A formaldehyde scavenger may be added to neutralize the formaldehyde that may be emitted by the lignocellulosic material.

In the present invention if a curative is used and it is used as a liquid or a liquid solution, then it is not premixed with the protein source prior to the protein source being mixed with the lignocellulosic component of the composites.

In one embodiment of the present process the formaldehyde-free curative comprises a PAE resin in amounts ranging from about 0.3% to about 40% of the lignocellulosic component of the composite of a dry weight basis, can be about 0.5% to about 5% and may be about 1% to about 3%. The PAE resin can contain less than about 0.1% of 1,3 dichloropropanol.

Amine-epichlorohydrin resins are defined as those prepared through the reaction of epichlorohydrin with amine-functional compounds. Among these are polyamidoamine-epichlorohydrin resins (PAE resins), polyalkylenepolyamine-epichlorohydrin (PAPAE resins) and amine polymer-epichlorohydrin resins (APE resins). The PAE resins include secondary amine-based azetidinium-functional PAE resins, examples include but are not limited to, Kymene™ 557H, Kymene™ 557LX, Kymene™ 617, Kymene™ 624 and ChemVisions™ CA1000, all available from Hercules Incorporated, Wilmington Del., tertiary amine polyamide-based epoxide-functional resins and tertiary amine polyamidourylene-based epoxide-functional PAE resins, examples include but are not limited to, Kymene™ 450, available from Hercules Incorporated, Wilmington Del. A suitable crosslinking PAPAE resin is Kymene™ 736, available from Hercules Incorporated, Wilmington Del. Kymene™ 2064 is an APE resin that is also available from Hercules Incorporated, Wilmington Del. These are widely used commercial materials. It is also possible to use low molecular weight amine-epichlorohydrin condensates as described in Coscia (U.S. Pat. No. 3,494,775) as formaldehyde-free crosslinkers. It is also feasible to use the low viscosity and high solids resins described in US Patent Publication 2011/0190423.

Other additives may be included in the composite and may be incorporated into the adhesive formulation such as extenders, viscosity modifiers, defoamers, diluents, catalysts, tack modifiers, formaldehyde scavengers, biocides, pH modifiers, and fillers. Urea may be added for numerous reasons as discussed above in the background section. If urea is added it can be pre-dissolved in water or pre-dissolved into a PAE solution. It can be added with other wet components or added separately. Many particleboard mills spray urea onto the composite furnish to lower formaldehyde emissions from the final board.

For the current process the level of urea can be from 0 percent to 5 percent of the lignocellulosic component of the composites on a dry weight basis, can be from about 1 percent to about 4 percent and may be from about 2 percent to about 3 percent dry weight basis. The urea can be sprayed separately onto the dry mixture of the protein sources and lignocellulosic material. “Dry” mixture doesn't mean the exclusion of all water because lignocellulosics, such as wood, and protein sources, such as soy flour, naturally contain water and are usually in a constant state of change of moisture content as they adjust to an equilibrium with the moisture in the air. “Dry” means the solids are movable as particles or pieces and there is no visible water. “Dry” when referring to the percentage of a formulation means the solids portion of an aqueous material or the weight of the material remaining after drying. For example, the weight of dry lignocellulosic material means the weight of the material minus its moisture content.

### Process

The current invention is directed toward processes for combining and utilizing the materials described above to form composites structures with various enhanced properties.

At the heart of the invention is the addition and dispersing of a protein source in the form of a powder, such as soy flour, to the lignocellulosic component of the composite. The combining of the protein source and lignocellulosic material or component occurs prior to the addition of the curative and or any other wet component. At the time of the addition of the protein source to the lignocellulosic material, both are dry, dry meaning the solids are movable as particles or pieces and there is no visible water. This means there is little or no adhesion between the particles or fibers or flakes or between the individual particles of the protein powder or between the protein source and the lignocellulosic material. The protein source powder(s) adheres lightly to the lignocellulosic material by electrostatic charges. In one embodiment of the current invention the adhesion between the protein source and the lignocellulosic material may be enhanced by applying an electrostatic charge to one or both of the dry components and possibly opposite static charges to each. The application of electrostatic charges is well known in the powder coating industry.

The mixing of the protein source and the lignocellulosic component of the composite may be by any means known in the art. One surprising aspect of the present invention was how easily and uniformly powders mixed with dry lignocellulosic fibers and particles or flakes.

Another aspect of the current process is that the protein source and the curative are never premixed prior to application of the protein source to the lignocellulosic material of the composites. It was unexpected that the curative functioned to react with or crosslink the protein source.

Another aspect of the process is that a protein source containing urease can be used in a composite with urea also being present in the composite. If a protein source containing urea were prepared as a dispersion or solution in water and that same adhesive mixture contained urea, then a rapid generation of ammonia would occur as the urease acted on the urea. The result is a high level of ammonia and CO2 gas which can pressurize a sealed container. There would be significant safety issues. In addition a rapid increase of pH would occur which could compromise the adhesive formulation and its performance. In the current process a composite formed may have ammonia formed if there is urease in the protein source and urea is added. However, unexpectedly the level of ammonia released is much reduced or the generation of ammonia is greatly diminished in the current process versus the state of the art wet process even when the total moisture content of the composite prior to pressing is the same.

In another aspect of the process of this invention, the above mentioned generation of ammonia that may occur in the process can be utilized. The generation of ammonia and the tempered increase of pH can aid performance when a curative that performs better at a high pH is used. For example, the PAE resins noted above will react faster at a pH of 7 compared to a pH of 5. Therefore, the process of the current invention can be used to obtain faster curing. An option of the current invention is a composite formulation comprising a urease containing protein source, a PAE resin as a curative, urea and a lignocellulosic material.

Another aspect the current invention allows greater latitude for the solids concentration of the liquid components added to the composite. The addition of the protein source as a powder, with typically less than 10% moisture content, reduces the amount of solids material that needs to be added as part of a water solution or dispersion. The moisture contents typically used in the preparation of composites and the limits of moisture content have been known in the composite industry for a long time. Too much moisture during the hot pressing of a composite, such as particleboard, can cause too much steam pressure to build up inside the composite structure such that when the pressure is released the composite blows apart or blisters or delaminates. Literature on the preparation of composites, such as particleboard, describes the typical operating window for moisture content. Manufacturers often adjust the moisture content of the lignocellulosic component. A large portion of every particleboard mill is the dryer sections used to control the moisture content of the wood prior to it being treated with adhesive. However, even with a low moisture content for the lignocellulosic material there needs to be a limit on the moisture added with the adhesive and other components or additives.

As an example consider a wood based composite with 95% wood, 2% of a protein source, 2% of a PAE curative, and 1% urea. Typically the urea is applied from a 35% solution (for ease of calculation say it is 33.3%). The protein source made as an aqueous solution/dispersion is typically contains only 33.3% concentration of the protein source before the viscosity becomes unmanageable. When the lignocellulosic material is for example wood, the wood is typically dried to about 5 parts moisture to 100 parts dry wood content. The composite structure would consist of 95 parts wood, 4.75 parts water from the wood, 2 parts protein source, 4 parts water from the protein source, 1 parts urea, 2 parts water from the urea solution, 2 parts PAE and the water from the PAE resin. The totals are 100 parts dry materials (here dry means the solids portion of an aqueous solution or dispersion) and 8.75 parts water plus the water from the PAE. The limit of water where a particleboard can be made varies some, but for the core portion of a particleboard it typically must be below 9.5 parts water to 100 parts of the dry materials (here dry means the free flowing components and there is no visible water; as defined above). If this is true then the water from the PAE portion could be at most 0.75 parts. Therefore, the PAE resins would have to be at almost 83% solids which, has not been achieved commercially with PAE resins. Conversely, if the soy were added as a powder, the water added with the soy (from its moisture content) would be about 0.12 parts and the total water content without the PAE water would be 6.87 parts. Then, 2.63 parts of water could be added with the PAE. That would mean the concentration of the PAE curative could be 43.2% solids, which can be achieved commercially. The current process using protein in powder form, provides much greater latitude for the moisture contents of other components in the adhesive.

In one embodiment of the current invention urea can be added separate from the curative. In another embodiment urea is added separate from diluents and other additives. Adding the urea separately provides the advantages of not having to premix the urea with other materials, it makes use of the urea addition lines already existing in many composite manufacturing mills and it allows separate adjustment of the level of urea which acts as a scavenger for formaldehyde. In one embodiment of the current invention, the PAE resin has a solids content greater than 50%.

In another aspect of the current invention the powdered protein source is combined with dry lignocellulosic material providing a more uniform mixture and a more uniform distribution of the protein source on the surface of the lignocellulosic material than a wet process, particularly a wet process where the adhesive is sprayed onto the lignocellulosic component.

### Tack

Tack, also known as green strength, is that ability of the unset and uncured but formed or shaped composite to hold its shape and remain cohesive from the time the composite is formed or shaped to the time it is set-up or cured or hardened. For this invention, setting-up means the process by which the adhesive goes from a liquid to a solid and generally is the point where substantial strength is developed (more than tack) in the formed composite structure. The adhesive may set-up by different means such as loss of water or by a curing mechanism, such as a heat or chemical reaction. Tack can also be considered the strength of the unset or uncured or unhardened composite.

Tack may be measured in different ways. For the purpose of the current invention it is measured, and thus defined, by forming a composite structure and testing its integrity. A 3″ by 10″ by ¼″ rectangular structure (sheet) is formed. The structure is made by combining the primary material of a composite (such as wood particles) with an adhesive, by the process of this invention or some other process, and then a certain weight of the uncured composite/adhesive mixture is measured and placed in a 3″×10″ (inner dimension) frame at a uniform thickness and then while still in the frame the uncured material is pressed with 6000 pounds of pressure (200 pounds per square inch (psi)) to form a formed structure. The frame is removed without disturbing the formed structure. The formed structure is made with a metal platen below it and between the platen and the structure is a thin pliable plastic sheet. The platen allows the formed uncured composite to be moved without influencing the tack results. After pressing, the platen, the plastic, and the structure are moved to a table. The edge of the platen is aligned with the edge of the table. The formed structure, which is riding on the plastic, is then slowly pulled over the edge of the table with the longest length of the structure perpendicular to the edge of the table. The pull over the edge of the table is done at a steady rate of about 1 cm/sec. The structure is moved by pulling the plastic sheet below it over the edge and downward from the top of the table. As each structure extends off the edge of the table it reaches a point at which it cannot support its own weight. The structure extending off the end of the table will break off and fall. The distance a sample extends off the end of the table before breaking off is taken as a measure of tack. The longer a sample extends over the edge, the higher the tack, that is, the more integrity it has. Samples are compared to get a relative effect. Samples are compared to control sample(s) prepared at the same time under the same conditions.

The tack test must be adapted slightly for different types of samples which may vary in ways such as adhesive content, composition, sample thickness, pressure used to form, moisture content, and rate of pull off the table.

One aspect of the current invention is that for a given overall uncured composite moisture content, it leads to enhanced tack versus the wet addition of all of the components.

### Structures

The present invention applies to composite structures comprised of the primary materials described above and held together by an adhesive. The composite can vary in the level of primary and adhesives materials as described above. For the current invention, the lignocellulosic composition is formed into a composite structure. The composite structure can take many forms from functional shapes, such as bowls, to large sheets such as used to make board products. The structures can be formed from, but are not limited to, loose particles treated with adhesive or sheets of fibers treated with adhesive. The structures can be formed prior to or after combining the adhesive and the wet material. The compositions of the structures can contain other materials such as waxes, dyes, catalysts, catalysts for the curing of the adhesive, other fillers, flame retardants, biocides, and other additives known in the composite industry. The wet portion of the adhesives may also contain these materials in either soluble or dispersed form and the additives may be premixed with the adhesive or added at the same time as the adhesive. Powdered or dry additives may also be added to the dry mixture of the powdered protein source and dry lignocellulosic material. The composites may also contain diluents, some diluents may alter cure properties, while others may act as plasticizers, and others may be present to increase the solids of the composition, and others may alter the rheology properties. The composite and wet or dry portions of the adhesive compositions may also contain a scavenger for formaldehyde. One such example is urea and another is dimethylurea.

Structures of the current invention are can be sheets used in the preparation of particleboard or MDF. Various methods known to those in the industry are used to form and press such sheets. Additionally, the current invention may be applied to one or more parts or layers of a composite structure.

### EXAMPLES

### Example 1

### Wet Process vs Dry Process

Preparation of a lignocellulosic particleboard is simplified by use of the process of the current invention (referred to as the dry process) versus the traditional process of mixing soy flour and water and adhesive as aqueous components. At the same time the dry process leads to enhanced strength of the composite. Strength for this example refers to the Modulus of Rupture (MOR) of the particleboard as measured with a three point bend test described below.

Example 1a: A traditional composite process (referred to as the wet process) was used as follows: 487 gram (g) of water was mixed with 102 g of glycerol, 0.4 g of a commercial defoamer, Advantage® 357, (Ashland Inc, Covington, Ky.) and 2 g sodium meta bisulfite. To this mixture was slowly added 213.4 g soy flour, Prolia® 200/90 (Cargill, Minnetonka, Minn.). The soy flour was thoroughly mixed in. The pH of the complete mixture was lowered by the addition of 8.36 g sulfuric acid to eliminate the urease in the soy flour. The mixture was held at the pH for 1 hour. 100 g of urea was then added along with 0.0036 g of a biocide. The final solids content was about 50%. 100 parts on a dry basis of this mixture was combined with 30 parts, on a dry basis, of a 55% solids low viscosity PAE resin. The PAE resin was prepared according to U.S. patent application Ser. No. 13/020,069 filed Feb. 3, 2011, published as US Patent Application No. 2011/0190423.

The combination of soy flour and PAE was used within 20 minutes of mixing. 100 parts of lignocellulosic material in the form of a wood furnish on a dry basis, mostly pine, in the form of particles, (such as used for making the core of particleboard) was placed in a Bosch 800 Watt Universal Plus Mixer, model MUM6N11 fitted with the manufacturers cookie dough paddles. The wood had a moisture content of about 2.5%. The mixer turned and flipped the wood as it stirred. The wood was stirred at the mixer's lowest speed and while being stirred the wood was sprayed from above with 7.5 parts on a dry basis of the above mixture of soy flour and PAE resin. The spraying was done over about 2 minute's time and was followed by a minute of mixing the wood in the blender. About 550 g of wood was treated in this manner.

Example 1b: The process of the current invention was used as follows. 100 parts lignocellulosic material in the faun of a wood furnish, the same type as used in Example 1a, was mixed with 2.88 parts Prolia® 200/90 soy flour. Mixing was done in the Bosch mixer described above. The wood particles, with approximately 2.5% moisture content, and soy flour as a powder, with approximately 6.5% moisture content, were mixed for 30 seconds (what is meant by dry is defined earlier and this case also meant the wood and flour were used as received). The high solids low viscosity PAE resin used in Example 1a, was mixed with water, glycerol and urea in the ratios 1.73:2.88:1.44:1.44 on a dry weight basis (except the water) to give a very low viscosity solution which was stable over time. With the “dry” process there was no need to acid treat the soy, or add sodium meta bisulfite to lower the viscosity, or add defoamer. The water level of the dry process PAE mixture was adjusted such that the lignocellulosic composition (wood plus soy flour plus curative plus additives) of each sample had the same overall moisture content. This was done to obtain results uninfluenced by water content, which can affect sample cure and density. The PAE mixture was sprayed onto the wood/soy mixture in the same manner as the wet material just described. The lower viscosity made it easier to spray. The spray time and post spray mix times were the same as for the wet process.

Each lignocellulosic composition for Examples 1a and 1b was handled and treated the same in the preparation of a particleboard. 614 g of the lignocellulosic composition was placed in a 10 inch by 10 inch frame, leveled, and cold pressed. The frame was then removed and the resulting structure was hot pressed to a ½ inch thickness using shims. The press conditions were 160° C., for 4 minutes. Each sample after being hot pressed was cooled to room temperature and then sealed in a bag after 5 minutes to maintain a constant moisture until they were cut and tested.

The Modulus of Rupture (MOR) of the samples was determined with a three point bend test. Eight samples of each example were tested and the strength values averaged. Each sample was 8″ long, 1″ wide, and 0.5″ thick.

Example 1a had an MOR of 1956 pounds per square inch (psi). Example 1b had an MOR of 2303 psi., thus demonstrating a surprising benefit of the dry process. Example 1a was repeated and the MOR was 1908 psi. The densities of the 3 samples were 45.6, 46.1, and 45.5 pounds per cubic foot. The moisture weight losses for the samples during hot pressing were 34.5 g, 34.2 g, and 33.4 g, respectively.

### Example 2

### Urea Added Separately

The dry process of the current invention offers multiple options for the addition of materials following the mixing of the lignocellulosic and the protein source. One such option is the addition of the wet materials individually.

Example 2a: The dry process of sample 1b was followed with the exception that to 100 parts dry wood was added 3.5 parts Prolia® 200/90 soy flour, on a dry basis, 1.73 parts high solids low viscosity PAE resin, and 2 parts urea. No glycerol was added. The moisture content of the treated composite furnish was adjusted to about 10%. The PAE, urea and the extra water, needed to obtain or give the desired moisture content of about 10%, were mixed together prior to being sprayed onto the soy flour/wood mixture.

Example 2b: The dry process of Example 2a was modified. A solution of 30% urea in water was sprayed separated from a mixture of the PAE and the extra water needed to get the same moisture content of the treated composites furnish as Example 2a. The two solutions were sprayed separately but at the same time onto the wood/soy flour mixture. Many particleboard mills use a separate spray of urea solution.

The lignocellulosic compositions were then made into particleboard samples by the same method described in Example 1.

Example 2a had an MOR of 2068 psi and an internal bond strength (“IB”) of 90 psi. Internal bond strengths were tested with 1″ by 1″ samples. The outside faces of the samples were glued to aluminum test fixtures and the samples pulled apart in the Z-direction. Example 2b had an MOR of 1932 and an 1B of 99. The samples were prepared a second time. The MOR with the PAE and urea premixed (repeat of Example 2a) was 1903 and with the urea sprayed separately (repeat of Example 2b) the MOR was 2027. The IB values were 90 psi and 88 psi. It is common for there to be some scatter in wood test samples. When considering both sets of data the conclusion is that adding the urea premixed with the PAE or separately gave similar strength results for each particleboard sample. The densities of the four samples were 45.0 pounds per cubic foot, 44.5 pounds per cubic foot, 44.5 pounds per cubic foot, and 44.4 pounds per cubic foot.

### Example 3

### Various Soy Flours and Urea Level

Useful particleboard may be made with different soy flours but some will have better strength properties under certain conditions.

Example 3a: The dry process of example 1 was used with 100 part dry wood, 4 parts of Prolia® 200/90 soy flour, and 1.85 parts PAE resin, the same PAE use in Example 1. Samples were made with 0, 1, and 2 parts urea, on a dry weight basis to 100 parts of dry wood. The urea and the water needed to obtain the desired moisture content were premixed with the PAE prior to spraying. The soy flour was premixed with the wood particles. The moisture content of the treated composite furnish prior to pressing was 10.5%. The boards were prepared by pressing in a 160° C. press for 4 minutes.

Example 3b: The same process was used as for Example 3a, except the soy flour used was Prolia® 200/20. For the 200/90 and the 200/20 the “90” and the “20” describe the PDI of the soy flour. The following table lists the results.

TABLE 1
MOR of Particleboard

| | Urea level | | |
|---|---|---|---|
| Soy flour | 0 parts | 1 part | 2 parts |
| 200/90 | 2228 | 2448 | 2568 |
| 200/20 | 1924 | 2200 | 2237 |

Soy flour with a high dispersability index illustrates better strength.

Example 3 also demonstrates that different levels of urea addition can be used in the process of the current invention and that the level of urea can impact the strength of the final particleboards.

### Example 4

### Various Protein Source

Various protein sources may be used in the protein portion of the adhesive used in the dry process of the current invention. Likewise various lignocellulosic materials may be used.

Example 4a to 4k: The same process used for Example 1b was used to make the following samples. To 100 parts dry wood was added 3 parts of a protein source, 1.73 parts of the same PAE resin as in Example 1, and 2.5 parts urea. The urea, PAE, and enough water to reach 10% moisture content for the treated composite furnish were premixed. The protein sources were mixed with the wood particles as in Example 1. Where a more than one protein source was used the mixture percentages were on a weight basis. The same total level of protein source and moisture content was used for each sample. Boards were cured by pressing for 4 minutes at 160° C.

Table 2 lists the various protein sources and combinations of protein sources used in the current process, Table 2 also lists the resulting MOR values, the density of the boards, and the IB strength values. Although differences were observed between the different protein sources, they all led to particleboard samples of reasonable strength and thus the process of the current invention is proved to be applicable to different protein sources.

TABLE 2
MOR and IB results for Example 4

| | Description | Raw MOR | Board Density | Avg. IB |
|---|---|---|---|---|
| 4a | soy flour | 2236 | 44.3 | 109 |
| 4b | corn gluten | 1733 | 44.2 | 46 |
| 4c | whey protein | 2456 | 45.3 | 137 |
| 4d | peanut flour | 1931 | 44.9 | 84 |
| 4e | wheat gluten | 2081 | 44.7 | 85 |
| 4f | 50/50 soy flour/corn gluten | 2271 | 44.9 | 124 |
| 4g | 50/50 soy flour/whey protein | 2491 | 45.1 | 142 |
| 4h | 50/50 soy flour/peanut flour | 2313 | 45.0 | 142 |
| 4i | 50/50 soy flour/wheat gluten | 2439 | 45.3 | 138 |
| 4j | soy flour | 2312 | 44.9 | 141 |
| 4k | 75/25 soy flour/dried egg | 2469 | 45.1 | 110 |
| | whites | | | |

Each protein source was in the form of a finely ground flour or powder. The soy flour was from Cargill, the corn gluten meal from ADM, the egg white from Aldrich chemical supply company, and the other materials from Bob's Red Mill, a flour supply company.

### Example 5

### Tack

Increased tack may be advantageous in the preparation of composites. Example 5a: The same process used for Example 1a with soy flour mixed with water and other additives was used except the lignocellulosic composition was not hot pressed but instead cold pressed into tack samples as per the tack test described above. To wood was added, by spraying and subsequent mixing, a mixture of water, soy flour, urea, and glycerol as prepared in Example 1a, which contained sodium metabisulfite, defoamer, and acid, and which was mixed with PAE. The ratio of the soy mixture to the PAE was 100 to 30 on a dry weight basis. The total amount of adhesive applied (the PAE and the soy mixture) was 7.5 parts to 100 parts wood, on a dry weight basis.

Example 5b: Approximately the same final board formulation was obtained with the dry process by mixing 100 parts wood and 2.88 parts soy four, and then treating the wood and soy flour mixture with a mixture of 1.73 parts PAE, 1.44 parts urea, and 1.44 parts glycerol. The same dry process as described in Example 1b was used. As in Example 1, the dry process did not require the addition of sodium bisulfite, or defoamer. It was far easier to spray the PAE/urea/glycerol/water mixture in this example than to spray the soy flour/PAE mixture of Example 5a.

The tack of Example 5a and Example5b were 8.0 centimeter (cm) and 11.1 cm, respectively.

Example 5c, Example 5d, and Example 5e: Tack was found to be related to the level of soy flour. More soy flour leads to more tack. With the same conditions described for Example 5b, except for no addition of glycerol, the level of soy flour was increased from 2 parts, to 3 parts, to 4 parts, on a dry weight basis, to 100 parts wood. The samples had tack values of 8.4 cm, 10.4 cm, and 13.2 cm, respectively. The results show more soy flour leads to more tack. A level of 3 parts or 4 parts soy flour would be very difficult if not impossible to obtain with the traditional wet process of Example 5a because the viscosity of the adhesive would be too high to spray at a solids high enough not to cause manufacturing issues as described above.

### Example 6

### Various PAE

PAE resins are used as curatives in the process of the current invention. Several different PAE resins were evaluated with the dry process described in Example 1b. To 100 parts (on a dry weight basis) wood particles, such as used for particleboard, was added 3 parts Prolia® 200/90 soy flour, 2.5 parts urea, and 1.8 parts of a PAE resin, all on a dry weight basis. The moisture content of the treated wood was the same for each sample at 8.5% and the hot press conditions for each was 4 minutes at 160° C. Four different PAE resins were compared.

PAE resins used were:

PAE #1 55% solids, low viscosity, 90% azetidinium content

PAE #2 25% solids, normal viscosity, 60% azetidinium content

PAE #3 25% solids, normal viscosity, 55% azetidinium content

PAE #4 20% solids, normal viscosity, 70% azetidinium content.

Each PAE resin gave roughly the same MOR performance, see Table 3. Compared to the traditional wet process described in Example 1a, the dry process offers more latitude for the use of lower solids PAE resins because one, can add high amounts of water to get to the same final moisture content.

TABLE 3
MOR of PARTICLEBOARD SAMPLES vs PAE RESIN

| Description | Raw MOR | Board Density | Avg. IB |
|---|---|---|---|
| PAE #1 | 2565 | 45.4 | 103 |
| PAE #2 | 2585 | 45.5 | 114 |
| PAE #3 | 2614 | 45.5 | 126 |
| PAE #4 | 2587 | 45.4 | 102 |

### Example 7

### Medium Density Fiberboard (MDF)

The process of the current invention is applicable to different composite materials, including the manufacturing of medium density fiberboard.

Example 7a: The soy flour and PAE mixture with urea and glycerol of Example 1a was sprayed onto the wood furnish (wood fibers) used to make MDF. The level of adhesive was 12 parts to 100 parts of the wood, on a dry weight basis. The adhesive was sprayed on as the wood fibers were being stirred in the same spraying and mixing process used in Example 1a. The mixing blades of the stirrer were replaced by a pair of whisks each with 6 tines. The total moisture content of the treated composite furnish was 11.5%. A board ¼ inch thick was prepared by pressing at 160° C. for 4 minutes. The MOR was measured with a 3-point bend test. The samples were 8 inches long, 1 inch wide, and ¼ inch thick.

Example 7b: Using the process of Example 1b, dry soy flour was mixed with the wood fibers to make an MDF board. The process was then the same as in Example 7a with the total adhesive level being 12 parts to 100 parts wood. The results for Example 7a and Example 7b are given in Table 4.

TABLE 4
MDF MOR results

| | Description | Raw MOR | Board Density (PCF) |
|---|---|---|---|
| 7a | wet process 12 parts adhesive | 2822 | 44.5 |
| 7b | dry process 12 parts adhesive | 2926 | 44.6 |

The process of the current invention led to an MDF board with at least equal strength to a wet process.

### Example 8

### Various Soy Levels (Not Possible with Wet Process)

A key aspect of the process of the current invention is that is allows for use of formulations high in the level of the protein component. This example demonstrates the preparation of wood particleboard composites containing relatively high levels of soy flour.

Example 8a: 100 parts wood was mixed was 8 parts of Prolia® 200/90 soy flour and sprayed to add 3 parts PAE resin of the type used in Example 1b.

Example 8b: 100 parts wood was mixed with 12 parts of soy flour and sprayed with 2 parts PAE of the type used in Example 1b.

The wood moisture content was 2.5%. The PAE was 55% solids. The soy flour moisture content was 5%. For each sample the total moisture in the lignocellulosic composition was 51.7 parts. Particleboard samples were prepared as previously described in Example 1.

The sample with 8 parts soy flour produced a board with an MOR of 2054 psi at a density of 47.2 pounds per cubic foot. The sample with 12 parts soy flour produced a board with an MOR of 1793 psi at a density of 47.3. The IB strengths of the samples were 109 and 98 psi, respectively.

### Example 9

### Isocyanate Cured

A particleboard sample was prepared in the following manner. 100 parts by weight of wood furnish of a dry basis, mostly pine, in the form of particles, (such as used for making the face of particleboard) was placed in a Bosch 800 Watt Universal Plus Mixer, model MUM6N11 fitted with the manufacturers cookie dough paddles. The wood had a moisture content of about 2.6%. To the wood was added 3.34 parts soy flour by weight. The soy flour moisture content was about 6%. The mixture was stirred about 15 seconds on the mixer's lowest speed after which water was sprayed on while stirring continued. 11.5 parts by weight of water was applied. Immediately following the application of the water, while stirring continued, 3.37 parts of poly(methylene diphenylisocyanate) (pMDI), Rubinate 1840 from Huntsman) was sprayed on. Total time for spraying was about 2 minutes. After the spraying was completed the treated wood was stirred for an additional 30 seconds. The treated wood was made into a 10 inch by 10 by 0.5 inch sample as in the examples above with pressing for 3.5 minutes at 160° C. The density of the sample was 45.3 pounds per cubic foot, and the MOR was determined to be 2343 psi. An isocyanate curing agent can be utilized in the current process.

### Example 10

### Simultaneous Mixing

600 g of fine wood pieces of the type used for making the face of a particleboard are placed in the Bosch mixer described above. The wood should have a moisture content of approximately 3%. As the wood is mixed 18 g of soy flour is slowly dusted into the wood with a hand flour sifter of the type commonly used in home baking. The sifter gives a fine spread of the soy flour onto the wood. The flour is added at a steady rate over a time of approximately one minute. The soy flour should have a moisture content of approximately 6%. Simultaneously, but separately, a liquid mixture of curative and additives and water are sprayed onto the wood at a close range, such that the spray nozzle is nearly touching the stirring wood. At times wood particles may be touching the nozzle. With this configuration, the spray does not directly contact the soy flour being dusted onto the wood until after the soy flour is on the wood. The curative mixture can consist of a 40% solids water mixtures with the 40% consisting of one part low molecular weight PAE resin, ⅓ part urea, and ⅙ part glycerol. A total of 60 parts of the aqueous mixture is applied over about one minute. The treated wood is mixed for 10 seconds following completion of the spraying. The mixture is subsequently made into a 10 inch, by 10 inch, by 0.5 inch particleboard sample by means described above with the hot pressing conditions of 3 minutes at 160° C. Appropriate testing can be done on the particleboard sample produced.

1. A method of preparing a lignocellulosic composite comprising the steps of combining one or more protein source(s) in powder form with one or more dry lignocellulosic materials to form a mixture; subsequently combining one or more curative(s) to the mixture forming a lignocellulosic composition; forming the resulting lignocellulosic composition into a composite structure; and curing the composite structure.

2. The method of claim 1, wherein the protein source comprises soy flour.

3. The method of claim 2, wherein the soy flour has a dispersability index greater than 50.

4. The method of claim 1, wherein the curative comprises formaldehyde based resin, isocyanate based resin; and/or polyamidoamine-epichlorohydrin resin.

5. The method of claim 1, wherein the curative is greater than 1 percent of the lignocellulosic composition on a dry weight basis.

6. The method of claim 1, wherein the lignocellulosic composition further comprises a formaldehyde scavenger.

7. The method of claim 6, wherein the formaldehyde scavenger is urea.

8. The method of claim 1, wherein the composite structure is particleboard or medium density fiber board.

9. The method of claim 8, wherein the particleboard is composed of multiple layers formed with a formaldehyde and lignocellulosic mixture and/or an isocyanate and lignocellulosic mixture or composition.

10. The method of claim 1, wherein the moisture level of the composite structure just prior to curing is less than 8% on dry lignocellulosic weight basis.

11. The method of claim 1, wherein the curative is substantially free of a formaldehyde based or formaldehyde generating compound.

12. The method of claim 1, further comprising separately combining one or more additives to the protein source; dry lignocellulosic material; lignocellulosic mixture; lignocellulosic composition and/or combinations thereof.

13. The method of claim 1, wherein the composite structure is cured by heat.

14. The method of claim 1, wherein the protein source contains urease and the composite structure contains urea resulting in an increase of pH after addition of the urea and before curing of the composite structure.

15. The method of claim 1, wherein the overall protein level of the lignocellulosic composition on a dry lignocellulosic weight basis is from about 0.5 to about 15%.

16. The method of claim 15, wherein the overall protein level of the lignocellulosic composition on a dry lignocellulosic weight basis is from about 1 to 5%.

17. The method of claim 1, wherein an electrostatic charge is applied to the powdered protein source.

18. The method of claim 1, wherein an electrostatic charge is applied to the dry lignocellulosic material.

19. A method of preparing a lignocellulosic composite comprising the steps of simultaneously combining one or more protein source(s) in powder form; one or more dry lignocellulosic materials; and one or more curative(s) thereby forming a lignocellulosic composition; forming the resulting lignocellulosic composition into a composite structure; and curing the composite structure.

20. A method of preparing a lignocellulosic composite comprising the steps of combining one or more protein source(s) in powder form with one or more dry lignocellulosic materials to form a mixture; combining one or more additive(s) to the mixture, wherein at least one of the additive(s) is a curative and the one or more additive(s) can be combined simultaneously with the protein source and lignocellulosic material mixture or subsequent to combining the protein source and lignocellulosic material thereby forming a lignocellulosic composition; forming the lignocellulosic composition into a composite structure; and curing the composite structure.
